(19) United States
(12) Patent Application Publication
(10) Pub. No.: US 2004/0003395 A1
(43) Pub. Date: Jan. 1, 2004

(54) Automatic display of a recommended program onto PIP display

(76) Inventors: Gutta Srinivas, Yorktown Heights, NY (US); Miroslav Trajkovic, Ossining, NY (US); Antonio Colmenarez, JR., Peekskill, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/184,509

(22) Filed: Jun. 28, 2002

(51) Int. Cl. H04N 7/025; H04N 7/10

(52) U.S. Cl. 725/34

(57) ABSTRACT

A method for automatically displaying an indication of a recommended program to a viewer. The method including: receiving program content; calculating a recommendation score for the received program content, the recommendation score indicating a likelihood that the viewer will approve of the received program content; and automatically displaying an indication of the received program content to the viewer if the recommendation score is above a predetermined threshold. Preferably, the indication is the display of the received program content, which is more preferably displayed on a picture-in-picture display and which can be switched to a main display, if desired, by the viewer.

### BACKGROUND OF THE INVENTION

1. Field of the Invention

The present invention relates generally to television recommenders for generating television program recommendations and more particularly to an automatic display of a recommended program onto a picture-in-picture (PIP) display.

2. Prior Art

PIP displays are well known in the art. Televisions (or other display monitors) so equipped can display a first program on a main display and a second program on the PIP. The PIP is generally smaller in size than the main display, but can also be a split screen. While the PIP is generally used to display a second program, they can also be used to display a program guide or other program information.

Furthermore, recommenders for recommending television programs to a viewer are also well known in the art. Such recommenders generally compute a recommendation score indicative of the likelihood that the viewer will approve of a particular program. The score is based on either a viewing history of the viewer and/or a voting system by the viewer. One example of such a device is the Tivo™ system available from Tivo, Inc., of Sunnyvale Calif. Although such devices have their advantages, they are generally active devices in that the viewer must actively query the device for recommended programs or choose from a list of recorded programs that the device deems desirable based on the recommendation score.

### SUMMARY OF THE INVENTION

Therefore it is an object of the present invention to provide a method and device for automatically displaying an indication of a recommended program to a viewer.

Accordingly, a method for automatically displaying an indication of a recommended program to a viewer is provided. The method comprising: receiving program content; calculating a recommendation score for the received program content, the recommendation score indicating a likelihood that the viewer will approve of the received program content; and automatically displaying an indication of the received program content to the viewer if the recommendation score is above a predetermined threshold.

Preferably, the automatically displaying of the indication is automatically displayed on a picture-in-picture display. The picture-in-picture display can be solid or transparent.

The automatically displaying of the indication preferably comprises automatically displaying the received program content to the viewer, more preferably on a picture-in-picture display. In which case, the method further comprises switching the received program content displayed on the picture-in-picture to a main display.

Alternatively, the automatically displaying of the indication comprises automatically displaying a message to the viewer, the message indicating the likely approval of the received program content, more preferably on a picture-in-picture display. Where the message is ignored by the viewer, the method preferably further comprises reminding the viewer of the message at a later time.

Also provided is a device for automatically displaying an indication of a recommended program to a viewer. The device comprising: a receiver for receiving program content; a recommender for calculating a recommendation score for the received program content, the recommendation score indicating a likelihood that the viewer will approve of the received program content; and means for automatically displaying an indication of the received program content to the viewer if the recommendation score is above a predetermined threshold.

The means for automatically displaying the indication preferably comprises means for automatically displaying the indication on a picture-in-picture display.

Preferably, the means for automatically displaying the indication comprises means for automatically displaying the received program content to the viewer, more preferably on a picture-in-picture display. In which case the device further comprises means for switching the received program content displayed on the picture-in-picture to a main display.

Alternatively, the means for automatically displaying the indication comprises means for automatically displaying a message to the viewer, the message indicating the likely approval of the received program content, more preferably on a picture-in-picture display. Where the message is ignored by the viewer, the device preferably further comprises means for reminding the viewer of the message at a later time.

Still further provided is a computer program product embodied in a computer-readable medium for automatically displaying an indication of a recommended program to a viewer. The computer program product comprising: computer readable program code means for receiving program content; computer readable program code means for calculating a recommendation score for the received program content, the recommendation score indicating a likelihood that the viewer will approve of the received program content; and computer readable program code means for automatically displaying an indication of the received program content to the viewer if the recommendation score is above a predetermined threshold.

Still yet further provided is a program storage device readable by machine, tangibly embodying a program of instructions executable by the machine to perform method steps for automatically displaying an indication of a recommended program to a viewer. The method comprising: receiving program content; calculating a recommendation score for the received program content, the recommendation score indicating a likelihood that the viewer will approve of the received program content; and automatically displaying an indication of the received program content to the viewer if the recommendation score is above a predetermined threshold.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 is a schematic illustrating a preferred implementation of the device of the present invention.

FIG. 2a illustrates an alternative display of the picture-in-picture display of FIG. 1.

FIG. 2b illustrates a portion of a preferred implementation of the control means of FIG. 1.

FIG. 3 is a flowchart illustrating a preferred implementation of a method of the present invention.

FIG. 4a illustrates portion A of the flowchart of FIG. 3.

FIG. 4b illustrates portion B of the flowchart of FIG. 3.

### DETAILED DESCRIPTION OF THE PREFERRED EMBODIMENT

Although this invention is applicable to numerous and various types of program content, it has been found particularly useful in the environment of video program content. Therefore, without limiting the applicability of the invention to video program content, the invention will be described in such environment.

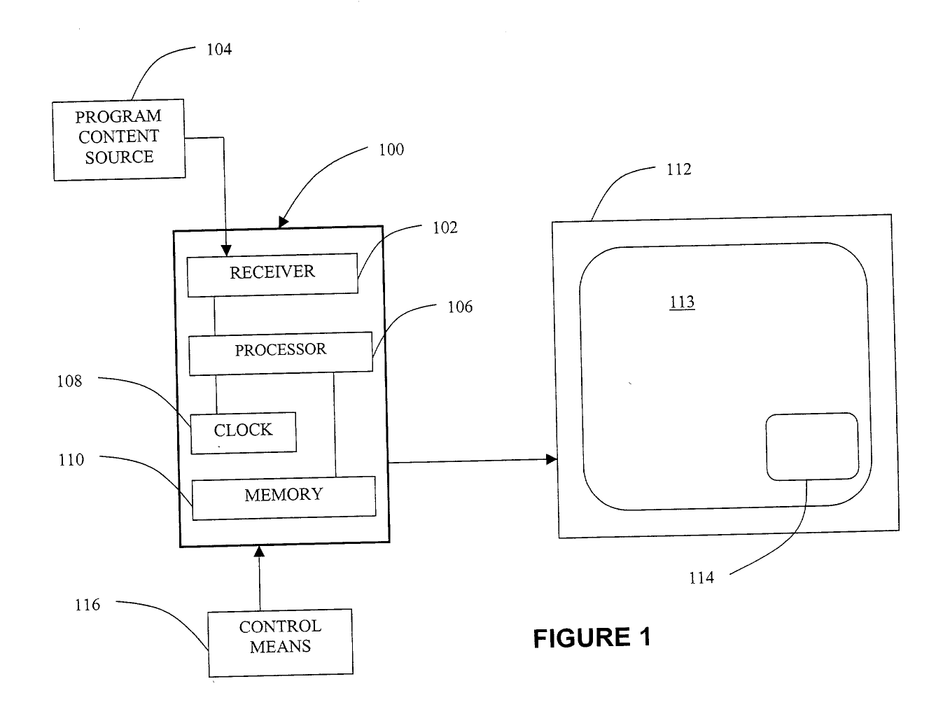

Referring now to FIG. 1, there is illustrated a device for automatically displaying an indication of a recommended program to a viewer, the device being generally referred to by reference numeral 100. The device 100 is preferably configured as a set-top box for use with a display, such as a television or computer monitor. The device has a receiver 102 for receiving program content, such as video movies, broadcast video programming and the like from a program content source 104. The program content may be sent and received by any medium known in the art, such as a broadcast television signal, a cable signal, a satellite signal, and an Internet connection. Receivers for receiving such signals are well known in the art.

The device 100 further includes a recommender for calculating a recommendation score for the received program content. Such recommenders calculate the recommendation score indicating a likelihood that a particular viewer will approve of the received program content and are well known in the art, such as that disclosed in U.S. application Ser. No. 09/466,406 entitled Method and Apparatus for Recommending Television Programming, filed on Dec. 17, 1999 and U.S. application Ser. No. 09/498,271 entitled Adaptive TV Program Recommender, filed Feb. 4, 2000, both of the disclosures of which are incorporated herein by their reference. The recommender is generally implemented in a processor 106 having a memory 110 and alternatively, a clock 108.

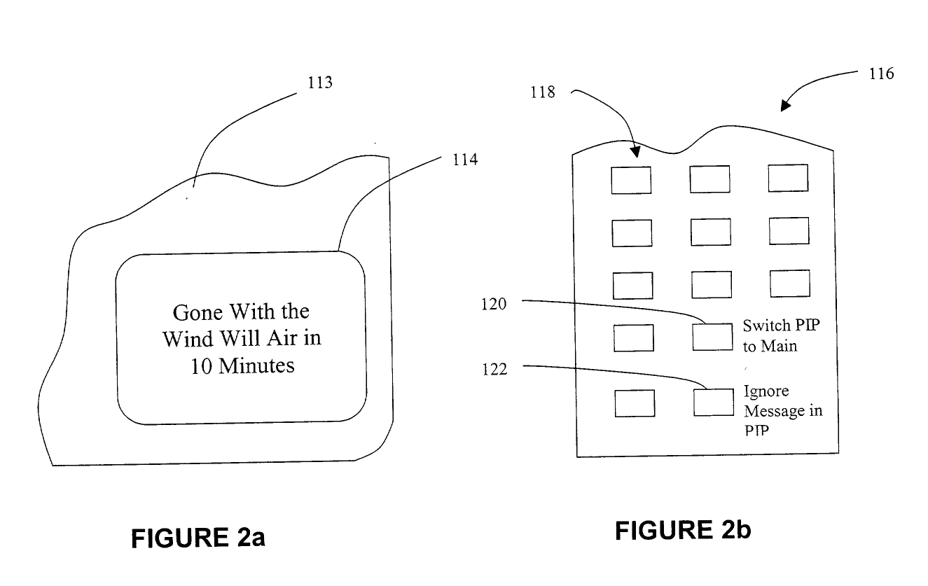

A display 112 is also provided and is operatively connected to the device 100. The display 112 is preferably a television having both a main display 113 and a picture-in-picture 114 (PIP) display. The PIP 114 is shown in more detail in FIG. 2a and can display still images, such as a textual message as illustrated in FIG. 2a or video. The display 112 can be either stand alone or integral with the device 100. The device 100 also has a control means 116, which is preferably remotely connected to the device, such as by infrared signals. The control means 112 preferably also controls functions relating to the display 112 and PIP 114. Such remote controls are well known in the art and typically have a plurality of buttons 118 or other switches such as the ones illustrated in FIG. 2b. Generally, each of the plurality of buttons 118 corresponds to a different function to be carried out by the device 100 and/or display 112.

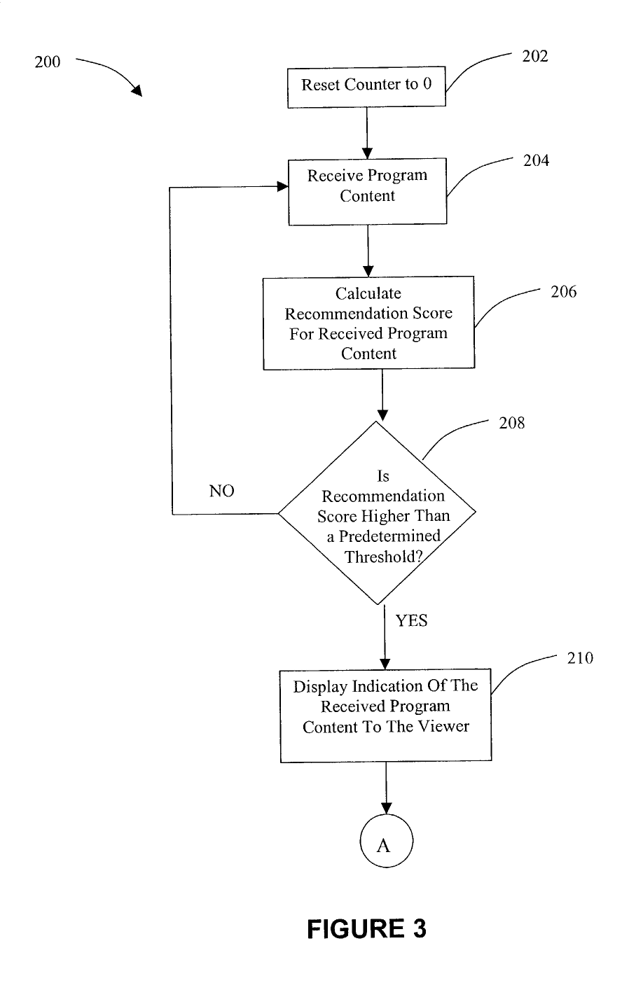

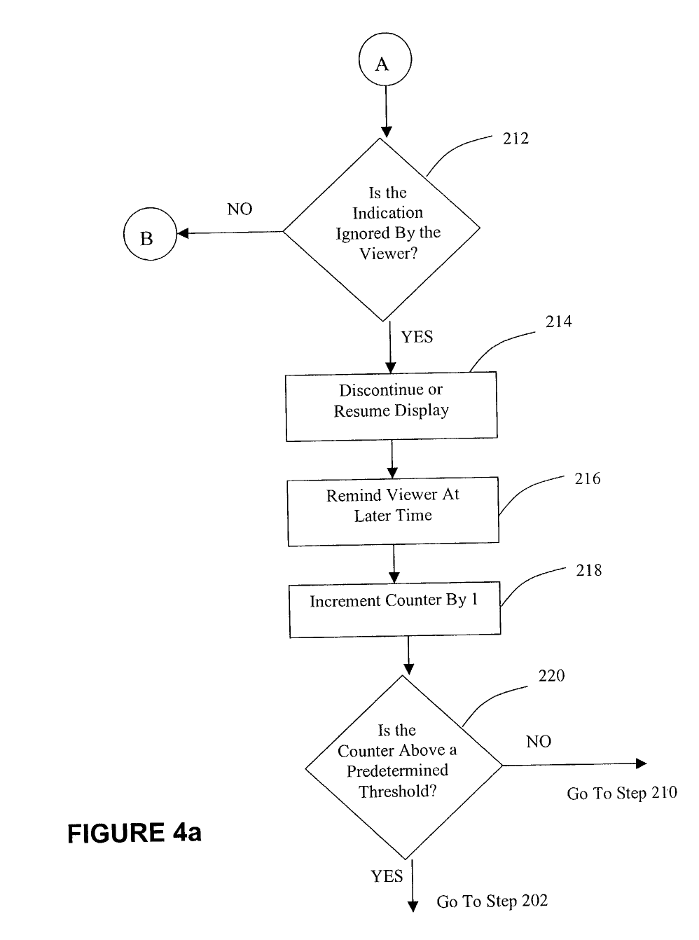

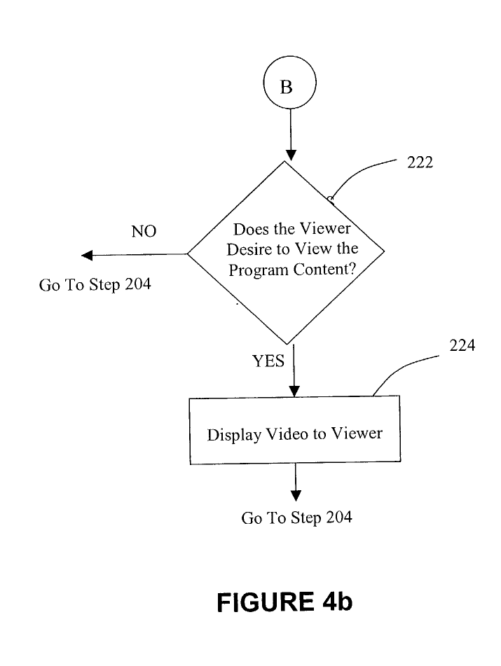

Referring now to FIGS. 3, 4a, and 4b a preferred implementation of a method for automatically displaying an indication of a recommended program to a viewer will now be discussed. The method comprises resetting a counter to zero at step 202 and receiving the program content at step 204. Those skilled in the art will appreciate that the program content can be actual video programs and/or a listing of programs and associated features from which the recommender can calculate a recommendation score. At step 206 a recommendation score is calculated for the received program content. As discussed above, the recommendation score indicates a likelihood that the viewer will approve of the received program content. At step 208, it is determined whether the calculated recommendation score is higher than a predetermined threshold. The threshold can be fixed or changeable by the viewer, preferably, through the control means 116. The predetermined threshold should be set such that any program content received which exceeds such threshold will be of interest to the viewer and merit indicating such to the viewer.

If the recommendation score is less than the predetermined threshold, the method proceeds along route 208-NO and loops back to step 204 to continue to receive program content. If the calculated recommendation score exceeds the predetermined threshold, then the method proceeds along route 208-YES to step 210 where an indication of the received program content is displayed to the viewer. The indication to the viewer can take many forms and be displayed in many ways. For instance, the indication is preferably automatically displayed on the picture-in-picture display 114. The picture-in-picture display 114 can be solid or transparent as is known in the art. Although the indication is preferably given on the PIP 114, those skilled in the art will appreciate that many possibilities exist for displaying the indication to the viewer, such as on a bottom line display or in a separate display. The indication may even be a visual display on the control means 116 such as a flashing LED. Furthermore, the indication does not have to be visual, but can be an audio display, such as a beep on the display 112, control means 116, and/or device 100. Lastly, the indication does not have to be displayed concurrently with something else the viewer is watching but may also take the place thereof.

Referring now to FIG. 4a, at step 212, it is determined whether the viewer ignores the indication. The ignorance on the part of the viewer is preferably a non-activity for a predetermined time period as counted by the clock 108 but may also be a positive indication that he or she wishes to ignore the indication of the program content such as by depressing button 122 on the control means 116. If the indication is ignored, the method proceeds along route 212-YES to step 214 where the display of the indication is discontinued or in the case where the indication takes the place of another display, the other display is resumed. At step 216, the viewer is preferably reminded of the indication at a later time as counted by the clock 108 and the counter is incremented by one at step 218. If the counter is determined not to be above a certain predetermined threshold at step 220-NO (i.e., the viewer has not ignored the indication too many times, e.g., 3 times) then the method loops back to step 210 where the indication is again displayed to the user. On subsequent indications, the type of display may change to more fully alert the viewer of the indication. For instance, the first indication may be a flashing LED, the second may be the flashing LED with an audio beep, the third may be a textual message on the PIP 114 and the fourth may be showing the actual program content on the PIP 114. The type of alert may also change depending upon how close it is to the time that the program content will broadcast. If it is determined that the counter is above the predetermined threshold, the method proceeds along route 220-YES to step 202 where the indication is no longer displayed to the user and the counter is reset to zero.

If the viewer does not ignore the indication, the method proceeds along route 212-NO to step 222, as illustrated in FIG. 4b. At step 222, it is determined whether the viewer wishes to view the program content. If not, the method proceeds along route 222-NO to step 204. If yes, the method proceeds along route 222-YES to step 224 where the program content, for instance a video broadcast program, is displayed to the viewer, after which, the method proceeds to step 204. Where a positive action on the part of the viewer is necessary, for instance, in desiring to view the program content, it is preferred that the viewer enter such action through the control means 116. Referring back to FIG. 2b, the control means preferably has buttons 118 corresponding to such actions, such as button 120 which switches the program content from the PIP 114 to the main display 113. Alternatively, button 120 can be used to discontinue the display of a message regarding the program content on the PIP 114 and displaying such program content on the main display 113. Furthermore, button 122 can be used to ignore the message in the PIP 114 or the display of the program content in the PIP 114.

As discussed above, the indication itself may take many forms. Preferably, where a certain received program content has a calculated recommendation score above the predetermined threshold, the program content is automatically displayed to the viewer. More preferably, such received program content is automatically displayed on the PIP 114. If the viewer desires to view the program content on the PIP, the PIP display can be switched to the main display 113, preferably by depressing a button 120 on the control means 116. The indication can also be a textual message, such as the one illustrated in FIG. 2a that the program content having a high recommendation score will be broadcast shortly. The textual message can be on the PIP or alternatively on a bottom or top line display. In this instance, the viewer can switch the main display 113 to a channel where the program content will be played or switch when it starts playing, preferably by using button 120 or other dedicated button 118 on the control means 116.

The device 100 as discussed above, in addition to being embodied as a “set-top” box for a television, may be embodied as any computing device, such as a personal computer or workstation having a processor and receiver. Furthermore, the display, in addition to being embodied as a television, may be embodied as any display for displaying video and/or image content connected to the device.

### EXAMPLE 1

A viewer who has a viewing history of watching classic dramas is watching the late news on channel 2 when the PIP is displayed and the message illustrated in FIG. 2a appears on the PIP display. The viewer ignores the message and the message is discontinued in 30 seconds. The message is again displayed on the PIP but this time reminds the viewer that “Gone with the Wind” will air in 5 minutes. The viewer again ignores the message and it is discontinued in 30 seconds. At the time when “Gone with the Wind” starts airing, It is displayed on the PIP. The viewer is tired and wishes to go to bed after the late news and presses button 122 to discontinue the PIP display and forcing the method to proceed to step 202.

### EXAMPLE 2

The same situation is presented as in Example 1, except when the message is displayed on the PIP that “Gone with the Wind” will air in 5 minutes, the viewer depresses button 120 and the main display switches to the channel that “Gone with the Wind” will air.

### EXAMPLE 3

The same situation is presented as in Example 1, except when the message is displayed on the PIP that “Gone with the Wind” will air in 5 minutes, the viewer depresses button 120 and the main display switches to the channel that “Gone with the Wind” will air when “Gone with the Wind” starts to air.

### EXAMPLE 4

The same situation is presented as in Example 1, however, when “Gone with the Wind” is displayed on the PIP, the viewer presses button 120 to switch the late news on the main display to “Gone with the Wind.”

The methods of the present invention are particularly suited to be carried out by a computer software program, such computer software program preferably containing modules corresponding to the individual steps of the methods. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for automatically displaying an indication of a recommended program to a viewer, the method comprising:
receiving program content;
calculating a recommendation score for the received program content, the recommendation score indicating a likelihood that the viewer will approve of the received program content; and
automatically displaying an indication of the received program content to the viewer if the recommendation score is above a predetermined threshold.

2. The method of claim 1, wherein the automatically displaying of the indication is automatically displayed on a picture-in-picture display.

3. The method of claim 2, wherein the picture-in-picture display is solid.

4. The method of claim 2, wherein the picture-in-picture display is transparent.

5. The method of claim 1, wherein the automatically displaying of the indication comprises automatically displaying the received program content to the viewer.

6. The method of claim 5, wherein the automatically displaying of the received program content is automatically displayed on a picture-in-picture display.

7. The method of claim 6, further comprising switching the received program content displayed on the picture-in-picture display to a main display.

8. The method of claim 1, wherein the automatically displaying of the indication comprises automatically displaying a message to the viewer, the message indicating the likely approval of the received program content.

9. The method of claim 8, wherein the automatically displaying of the message is automatically displayed on a picture-in-picture display.

10. The method of claim 8, wherein the message is ignored by the viewer, the method further comprising reminding the viewer of the message at a later time.

11. A device for automatically displaying an indication of a recommended program to a viewer, the device comprising:
a receiver for receiving program content;
a recommender for calculating a recommendation score for the received program content, the recommendation score indicating a likelihood that the viewer will approve of the received program content; and
means for automatically displaying an indication of the received program content to the viewer if the recommendation score is above a predetermined threshold.

12. The device of claim 11, wherein the means for automatically displaying the indication comprises means for automatically displaying the indication on a picture-in-picture display.

13. The device of claim 11, wherein the means for automatically displaying the indication comprises means for automatically displaying the received program content to the viewer.

14. The device of claim 13, wherein the received program content is automatically displayed on a picture-in-picture display.

15. The device of claim 14, further comprising means for switching the received program content displayed on the picture-in-picture display to a main display.

16. The device of claim 11, wherein the means for automatically displaying the indication comprises means for automatically displaying a message to the viewer, the message indicating the likely approval of the received program content.

17. The device of claim 16, wherein the message is automatically displayed on a picture-in-picture display.

18. The device of claim 16, wherein the message is ignored by the viewer, the device further comprising means for reminding the viewer of the message at a later time.

19. A computer program product embodied in a computer-readable medium for automatically displaying an indication of a recommended program to a viewer, the computer program product comprising:
computer readable program code means for receiving program content;
computer readable program code means for calculating a recommendation score for the received program content, the recommendation score indicating a likelihood that the viewer will approve of the received program content; and
computer readable program code means for automatically displaying an indication of the received program content to the viewer if the recommendation score is above a predetermined threshold.

20. A program storage device readable by machine, tangibly embodying a program of instructions executable by the machine to perform method steps for automatically displaying an indication of a recommended program to a viewer, the method comprising:
receiving program content;
calculating a recommendation score for the received program content, the recommendation score indicating a likelihood that the viewer will approve of the received program content; and
automatically displaying an indication of the received program content to the viewer if the recommendation score is above a predetermined threshold.
